(19) United States
(12) Patent Application Publication
(10) Pub. No.: US 2004/0098739 A1
(43) Pub. Date: May 20, 2004

(54) Method and apparatus for providing digital set top box function and using television's remote control to control same

(76) Inventor: Selim Shlomo Rakib, Cupertino, CA (US)

Correspondence Address: RONALD CRAIG FISH, RONALD CRAIG FISH, A LAW CORPORATION, POST OFFICE BOX 2258, MORGAN HILL, CA, 95038, US

(21) Appl. No.: 10/295,184

(22) Filed: Nov. 16, 2002

(51) Int. Cl. H04N 7/173; H04N 5/50; H04H 9/00; H04N 7/16

(52) U.S. Cl. 725/15; 725/131; 725/139; 348/731

(57) ABSTRACT

A process for refurbishing analog set top tuner/decoders which are not compatible with digital cable to convert same into a digital set top tuner/decoder which can tune any channel on a digital cable system and convert the digital data received on that channel into a video signal. The process comprises forming a replacement circuit and mounting said replacement circuit on the motherboard of the target set top tuner/decoder and then making circuit breaks at the appropriate points on the motherboard of said target set top tuner/decoder and connecting the appropriate points on the replacement circuit to the appropriate circuit breaks to complete the conversion. Also disclosed is a digital tuner/decoder which eliminates the need for the remote by picking up signals from the television's own local oscillator generated when an analog TV channel has been requested, and maps those to the desired digital channel and PID information, recovers the digital data and modulates onto an RF carrier having the frequency of the requested analog TV channel.

This application is a continuation-in-part of a prior U.S. patent application entitled Method and Apparatus For Refurbishing Analog Set Top Box To Provide Digital Set Top Box and Optional DOCSIS Cable Modem Capability filed on Nov. 13, 2002, Ser. No. ______.

### BACKGROUND OF THE INVENTION

There are currently a vast number of analog set top boxes that cable system operators have deployed. These set top boxes are used to couple the hybrid fiber coaxial cable system to the subscriber's television set. The old way to deliver cable TV content was analog with one TV signal per 6 MHz channel. The new way to deliver TV programs is digital with multiple programs delivered in compressed MPEG transport streams such that 10-12 programs can be delivered digitally over a single 6 MHz channel. This frees up a large amount of bandwidth, and allows cable operators to provide more regularly scheduled programs in addition to many pay per view channels and many video on demand channels. MPEG compression compresses a raw digital representation of a television program down to between 2.5 and 3.5 megabits per second. DOCSIS 2.0 QAM 64 and QAM 128 modulation bursts with 5.12 megasymbols per second symbol rate provide 38 megabits per second throughput per channel and occupy 6 MHz of bandwidth. Thus 10-12 video channels can be transmitted on a single DOCSIS 2.0 512 megasymbol per second QAM 128 channel.

Existing analog set top boxes only allow the user to flip between different channels. They do not have facilities to provide display of digital data which displays the program schedule or information about particular programs such as the actors and plot synopsis.

It is therefore, very advantageous to deploy digital set top boxes to replace analog set top boxes in the homes of subscribers. However, because the cable operators already have a substantial amount of capital invested in the deployed analog set top boxes, a need has arisen for a way to refurbish those analog set top boxes to make them compatible with digital cable delivery of video and broadband services via DOCSIS 2.0, 1.1 or 1.0 digital services.

Further, most homes that have cable TV service have television sets which are analog but cable ready in that their tuners can tune to channel numbers which number up into the 100s or at least have televisions that have UHF tuning capability so that they can tune up to at least channel 68 or higher. A refurbished analog set top box which has digital capability still requires that the original remote for the set top box be used to change the channels to a desired digital channel. It would be advantageous to eliminate this remote and have digital set top box capability without needing a separate remote control for the digital set top box. Remote controls have a tendancy to get lost or destroyed, and each one that can be eliminated decreases clutter in the house, reduces frustration when the remote is lost and the channel cannot be changed and lessens the annual battery expenditure.

Set top boxes also add additional clutter, and, in some cases will not fit in the cabinet the TV sits in because there is not enough room. People tend to want as big a TV as they can fit into the space that they have, and this sometimes leads to a tight squeeze between the top of the TV and the cabinet in which it sits, which does not leave enough room for the set top box to sit on top of the TV where it is in a position to receiver infrared commands. It would be much more convenient to have a digital set top box which does not have to sit on top of the TV and can sit behind it or be mechanically supported by the RF input of the TV in the form of a dongle and which determines which digital channel the user wishes to view without the need for a separate remote control for the digital set top box. Thus, a need has arisen for a device which has the capability of a digital set top box but which does not require its own remote and which does not have to sit on top of the TV or anywhere within line of sight of the viewers.

### SUMMARY OF THE INVENTION

The genus of processes within the teachings of the inventionis characterized by the shared characteristics of: any RF receiver and frequency counter which can determine the frequency being generated by a local oscillator in a tuner in a conventional television which has been tuned to a requested analog TV channel; any digital video tuner/decoder circuit with any control circuit coupled to the receiver/frequency counter which can deduce the analog TV channel to which the conventional TV has been tuned from the frequency generated by the local oscillator of the TV and which maps that information to the frequency of a corresponding digital TV channel, recovers MPEG packets having a PID which maps to the requested analog TV channel, converts those packets to an analog TV signal and remodulates onto an RF carrier having the frequency of the requested analog TV channel. This genus will be referred to as the digital tuner/decoder spy genus or simply the spy dongle.

Also disclosed herein is a refurbished analog set top box (tuner/decoder) which has been converted from an analog set top box to a digital set top tuner/decoder but which requires use of the original analog set top box IR receiver and its own remote. Both the refurbished digital set top tuner/decoder which has its own remote and the species within the digital tuner/decoder spy genus can be managed from the CMTS by in-band DOCSIS management and control information sent on the HFC and recovered by the DOCSIS cable modem in the digital set top tuner/decoder or a DOCSIS cable modem chip set in the spy dongle.

### BRIEF DESCRIPTION OF THE DRAWINGS

FIG. 1 is a block diagram of a typical analog set top decoder box.

FIG. 2 is a block diagram of a typical replacement circuit to make an analog set top box into a digital set top box.

FIG. 3 is a diagram of a typical mounting and connectionof a replacement circuit board.

FIG. 4 is a diagram of the connections of a digital television viewing system which uses a digital tuner/decoder which has no remote control and which does not have to be placed within line of sight of the viewer to receive infrared commands like most digital set top boxes.

FIG. 5 is a more detailed block diagram of the tuner/decoder 120 that does not require its own remote and which provides digital video tuning capability.

FIG. 6 is a diagram of one embodiment of a lookup table that maps local oscillator frequency to several factors needed to control the invention.

### DETAILED DESCRIPTION OF THE PREFERRED AND ALTERNATIVE EMBODIMENTS

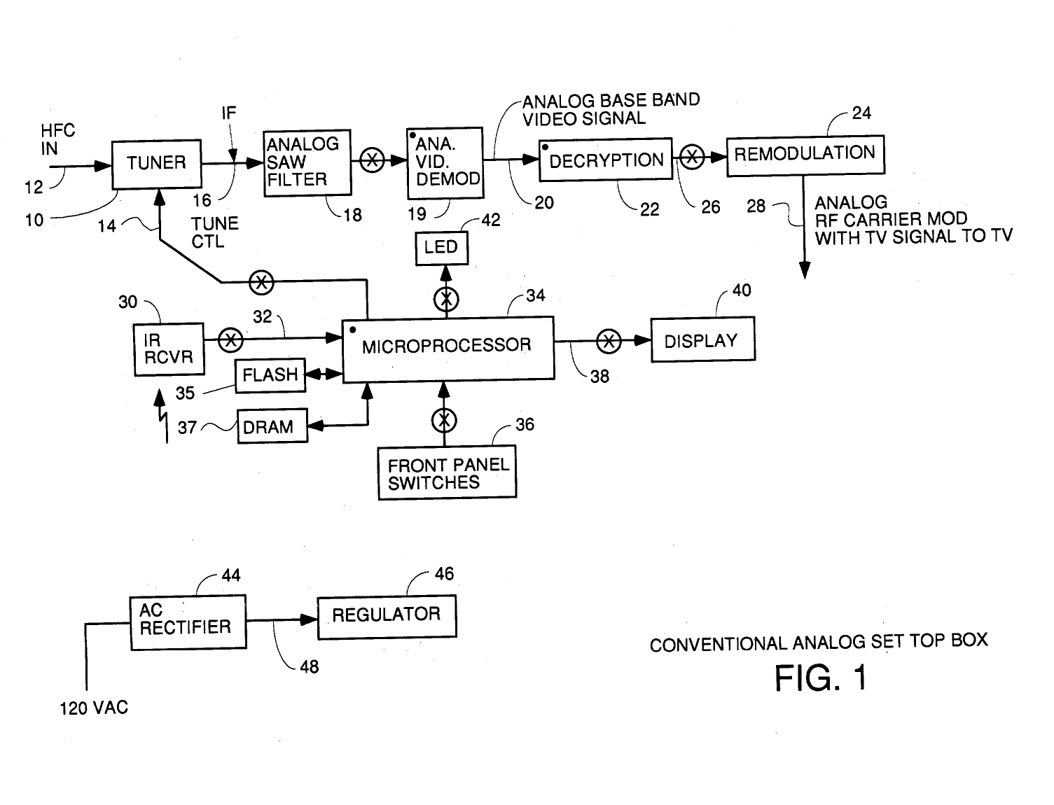

FIG. 1 is a block diagram of a typical analog set top decoder box. An RF tuner 10 receives a whole spectrum of radio frequency CATV signals at different frequencies from hybrid fiber coaxial cable system 12, each bearing a different program. A tuning signal on line 14controls which channel the tuner selects. The resulting selected channel is mixed down to an intermediate frequency on line 16 which is at the center frequency of an analog SAW filter 18. The output of the SAW filter is demodulated in an analog video demodulator 19. The SAW filter is a passband filter with sharp rolloff skirts. It filters out noise outside the selected channel. The filtered analog IF signal is then demodulated in the demodulation section, and a baseband analog video signal is output on line 20 to a decryption circuit 22. The decryption circuit unscrambles the analog video signal, and makes sure it does not get through if the user does not have an authentic decryption key. A remodulation circuit 24 then remodulates the decrypted baseband video signal on line 26 onto an radio frequency carrier having the frequency of channel 3 or channel 4 of the tuner of a television set coupled to output coax 28.

An infrared receiver 30 receives infrared commands from a remote control to change channels and converts these infrared signals to electrical signals on line 32. Microprocessor 34 receives these signals on line 32, and possibley receives other signals from front panel switches 36 if front panel switches are present, and converts commands to change channels to a tuning command on line 14. The microprocessor also displays the current channel via signals on line 38 to segment display 40. The microprocessor has flash memory 35 and DRAM 37 to store its program and data, respectively.

The microprocessor 34 may also indicate the status of the unit through LEDs 42. The set top box also includes an AC rectifier 44 to convert 120 volts AC wall power to DC voltages needed by the circuity in the set top box. A regulator 46 smoothes out the DC output and regulates the voltage thereof and may generate several different DC voltages from a single DC voltage input on line 48.

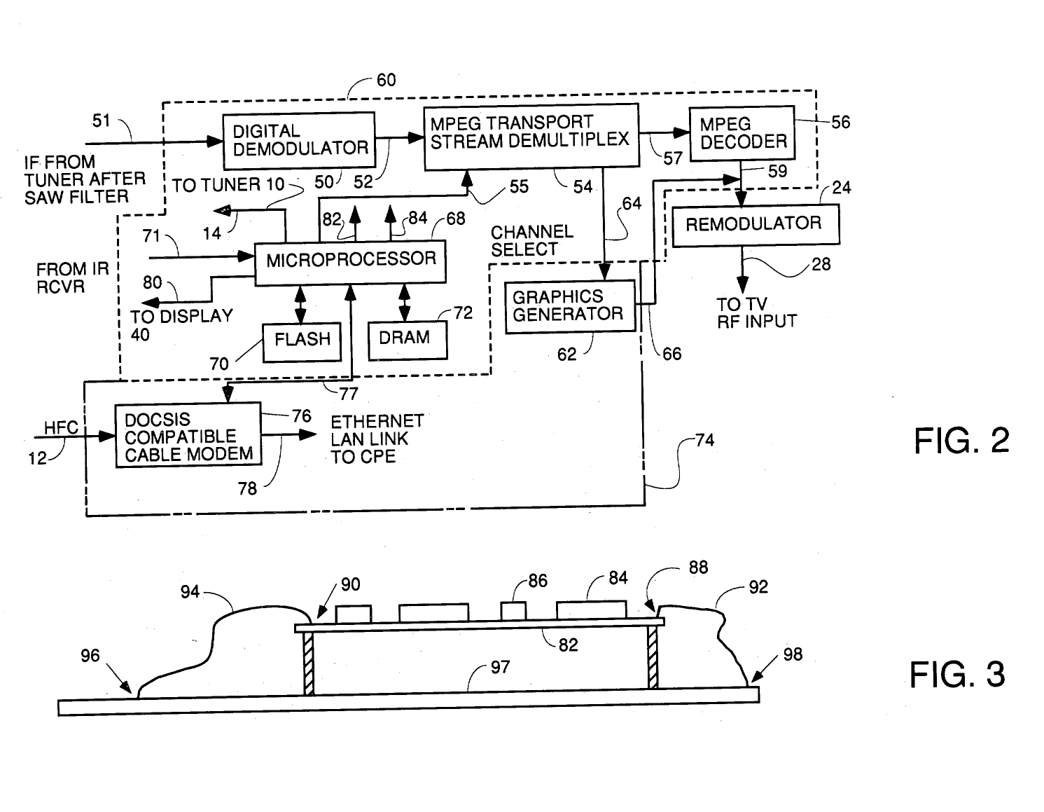

Referring to FIG. 2, there is shown the circuitry needed to convert the analog set top box of FIG. 1 to a digital set top box. The intermediate frequency signal on line 51 from the tuner 10 in FIG. 1, after filtering by the SAW filter 18, is demodulated by a known digital video demodulator circuit 50. Broadly speaking, the digital video demodulator 50 undoes the interleaving and Reed Solomon block encoding to add parity bits (it uses the parity bits to detect and correct errors) and undoes the encoding into constellation points of the MPEG packet data to reconstruct the original baseband MPEG transport stream.

A baseband signal MPEG transport stream in a digital representation is output on line 52 to an MPEG transport stream demultiplexer 54. In digital video and DOCSIS downstreams, video programs the various broadband services are encoded into MPEG packets, and each different service has a different code called a PID or program identifying information in the packet headers so that the different packets can be sorted into the different programs and kept together. This is done by the transport stream demultiplexer 54 which is a known circuit from existing digital set top boxes. A channel select signal on line 55 controls the transport stream demultiplexer and tells it which particular program in the MPEG transport stream whose packets are to be culled out. The culled packets are output line 57.

A known MPEG decoder 56 decodes the MPEG packets on line 57 belonging to the selected MPEG stream and converts the compressed MPEG data therein to a baseband analog video signal on line 59. In some embodiment, the baseband video signal may be output in parallel at baseband video and audio output jacks of the commonly used RCA variety or at an S-video output jack. In some embodiments, this is the only output of the video signal. In most embodiments however, for backward compatibility with TVs that do not have baseband video inputs, the analog video signal on line 59 is coupled to the input of the remodulator 24 from the original set top decoder box which modulates the baseband video signal onto an RF carrier on line 28 at the frequency of channel 3 or 4 for input to the RF input of a television set.

A known graphics generator 62 receives digital supplementary data from the transport stream demultiplexer on line 64. This supplementary data includes data such as the name of the program, the time it starts and finishes, the actors and a plot summary or any other auxiliary data useful to the user. This data is converted into graphics video signals on line 66 and fed to the input of the remodulator for display on the television.

A microprocessor 68 receives channel selection commands from the IR receiver via line 71 and, under the control of a program stored in flash EEPROM 70, it generates suitable channel select commands on line 55 for the MPEG transport multiplexer circuit 54 to cause the desired packets to be culled out of the MPEG transport stream and generates a tuner control signal on line 14 to control tuner 10 in FIG. 1. The microprocessor is coupled to DRAM 72 to store data. The microprocessor 68 is also coupled by bus 80 to the display 40 in FIG. 1, and is coupled to LEDs 42 by line 82. Microprocessor 68 can also be used to authenticate users and may be coupled to an access card reader (not shown). In alternative embodiments, a separate authentication circuit of a type known to digital set top boxes (not shown) is included in the circuitry of FIG. 2 at a suitable point. The microprocessor 68 is also coupled by line 84 to the front panel switches. The word “line” as it is used herein denotes as many separate conductors as are necessary to communicate appropriate signals with the particular device to which the line is coupled.

The circuitry shown in FIG. 2 inside dashed line 60 is all that is necessary to emulate the channel picking functionality of the analog set top box for a digital video delivery HFC system 12. The circuitry inside dashed line 60 replaces the circuitry in FIG. 1 with dots in the upper left hand corners and all the other circuitry is re-used. In some embodiments where the flash memory 35 and DRAM 37 in FIG. 1 are big enough to serve for the digital circuitry of FIG. 2, they are re-used, but in other embodiments, they are replaced by flash 70 and DRAM 72 in FIG. 2.

In more complex embodiments, where the user wants the convenience of graphics with program information and other broadband services that can be sent over a DOCSIS downstream, the circuitry inside dash-dot-dot line 74 is added to the replacement circuitry. The added circuitry is the graphics generator 62 and any known DOCSIS compatible cable modem 76. The cable modem is coupled to the HFC system 12 and outputs DOCSIS data on a local area network link 78 which is coupled to customer premises equipment such as computers, digital phones and FAXes and any other equipment that can use DOCSIS data. In some embodiments, the cable modem 76 is omitted and in other embodiments, the graphics generator 62 is omitted. In embodiments where the DOCSIS cable modem 76 is included, in-band management of the digital set top box from the CMTS can occur by sending management and control data to the CM 76 on a DOCSIS channel. The management and control data is output to the microprocessor 68 via line 77 and is used by the microprocessor to manage the digital set top box.

The circuitry in FIG. 2, or the previously identified subsets of the various embodiments described herein, is typically placed on a “daughter board” printed circuit board (PCB) which is mounted physically to the “mother board” PCB of the analog set top box which contains the circuitry of FIG. 1. Typically, this daughter board is mounted to the motherboard at the location of the microprocessor 34 and flash and DRAM chips 35 and 37 which are typically removed from the motherboard. The daughter board has connection pads thereon. The points in the circuitry marked with X in a circle on the block diagram of FIG. 1 are the typical places where the circuitry of FIG. 2 connects to the circuitry to be re-used from the circuit of FIG. 1. The circuit board traces at these Xs is broken and one or more wires as needed are soldered from the point of the break (on the appropriate side of the break) to the appropriate connection pad on the daughter board to make the circuit.

The daughter board can be a conventional PCB with integrated circuits that perform all the functions of FIG. 2 mounted thereon and interconnected suitably by PCB traces to form the circuit of FIG. 2 or any of the embodiments described above. The appropriate inputs and outputs of the circuit of FIG. 2 (or any of the alternative embodiments) are then coupled to connection pads on the daughter board, and the connection pads are connected in any way to the appropriate sides of the circuit breaks marked by Xs in FIG. 2. Typically, this will be done by soldering wires from the connection points on the daughter board to the circuit breaks.

In alternative embodiments, the daughter board can be constructed using a multichip module (MCM). An MCM is comprised of a substrate or support of a single integrated circuit package on which is mounted the individual integrated circuit dies of all the circuits (or the appropriate subset thereof depending upon the embodiment) of FIG. 2. These die are mechanically supported by an adhesive on the substrate and appropriate connections between them are wire bonded. The resulting circuit is then encased in a protective epoxy or other coating and the resulting MCM (which looks like an integrated circuit with a single die therein) is mounted on the daughter board in a conventional way. The pins of the MCM are then coupled to connection pads by conductive traces on the daughterboard PCB, and those connection pads are coupled to the appropriate break points on the circuit of FIG. 1.

In embodiments where the amount of circuitry is too much to fit onto a single MCM substrate, two or more MCM packages can be used and suitably connected by conductive traces on the daughter board. The appropriate pins of the MCM packages are then coupled to connection pads on the daughter board and to appropriate break points in the circuit of FIG. 1 to complete the digital set top box conversion.

FIG. 3 is a drawing of a typical mounting of a daughter board on a mother board. PCB 82 is the daughter board and has integrated circuits mounted thereon of which ICs 84 and 86 are typical. ICs 84 and 86 also represent one or more MCMs in MCM embodiments. Conductive trace, not shown, on the daughter board couple the ICs together and to connection pads at 88 and 90. Wires 92 and 94 are typical of the plurality of wires that couple the connection pads on the daughter board to circuit breaks on the mother board 97 of which circuit breaks at 96 and 98 are typical.

The advanatage of re-furbishing analog set top decoder boxes as described herein is that the following parts can be re-used to leverage the costs of production substantially downward: the enclosure; the power supply and regulator circuitry; the front panel switches, if any; the LEDs; the display; possibly the flash and DRAM memories; the infrared receiver; the tuner; the analog SAW fitler and the remodulation circuit. Re-use of these parts can substantially reduce the cost of manufacture of digital cable compatible set top boxes.

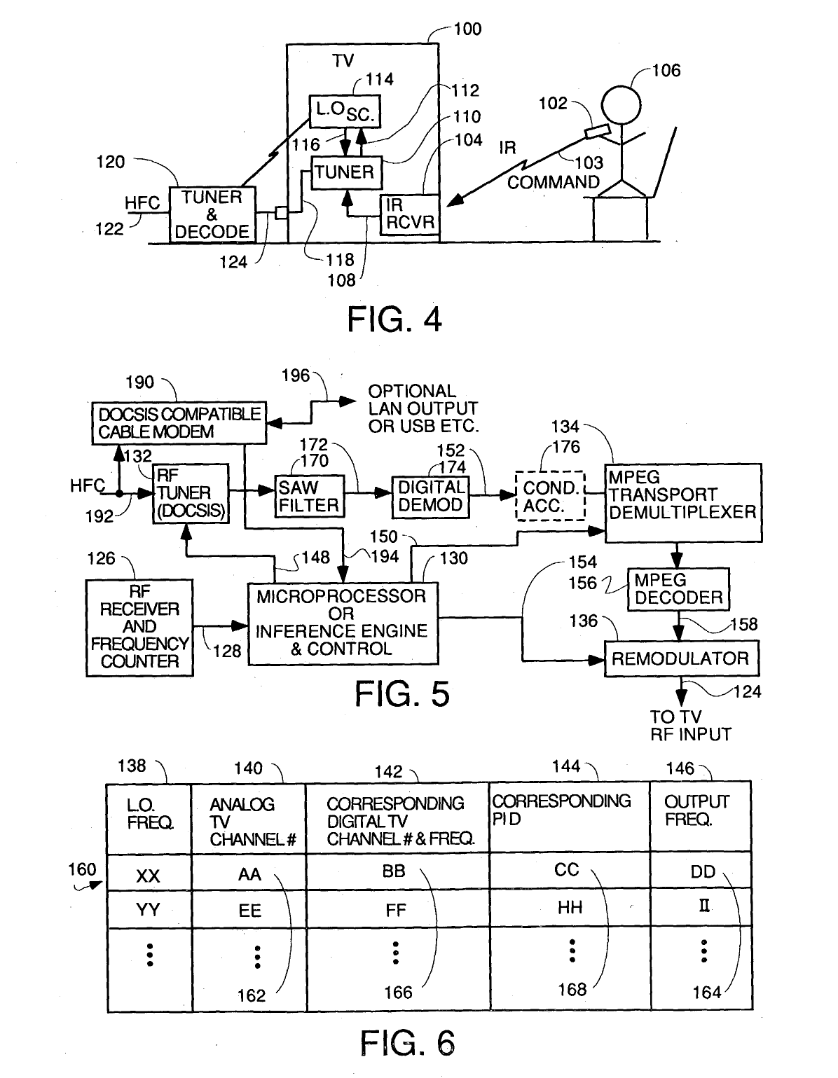

Referring to FIG. 4, there is shown a diagram of the connections of a digital television viewing system which uses a digital tuner/decoder which has no remote control and which does not have to be placed within line of sight of the viewer to receive infrared commands like most digital set top boxes. Television 100 has a remote control 102 which sends infrared commands 103 from user 106 to infrared receiver 104 in the TV. The infrared receiver 104 receives and decodes these infrared commands and sends electrical command signals on line 108 to the television's tuner 110. The tuner 110 is capable of tuning to 158 different channel numbers if the TV is cable ready or to at least channel 69 if the TV is just a VHF and UHF tuner. As the tuner is commanded to tune to a different TV channel, it sends a command on line 112 to local oscillator 114 telling it what frequency local oscillator signal to generate on line 116. The local oscillator signal on line 116 is used by the tuner to mix the incoming RF signal on line 118 down to an intermediate frequency where filtering and other conventional processing by circuitry which is not shown is accomplished. All this circuitry is designed to work with old fashioned analog TV channels which have different center frequencies and which are 6 MHz wide in bandwidth.

A typical DOCSIS 6 MHz wide RF signal can contain 10-12 different programs in digital compressed video. It is therefore very desirable for cable system operators to supplant these analog CATV FDMA video channels which can deliver at most 158 different programs with 158 different DOCSIS channels, each with 10-12 subchannels or logical channels each of which delivers a different compressed video program or other useful data. This multiplies by a factor of 10-12the number of channels available for downstream delivery of digital video, broadband internet access, IP telephony services, DSL over cable, etc.

Digital video and other broadband services is delivered over DOCSIS cable systems using MPEG transport streams. These streams are comprised of MPEG packets each of which has an MPEG header which contains a PID field followed by a large number of data packets that contain the compressed video or other data. The PID field contains a PID code which identifies the particular program or other service to which the data in the packet belongs. One digital channel as that term is used herein means one 6 MHz bandwidth RF carrier at some center frequency which is modulated with constellation points generated from the forward error corrected MPEG transport stream. The MPEG transport stream has MPEG packets in it for 10-12 subchannels, each of the subchannels having a different, unique PID which can be mapped to the program whose data is on that subchannel.

To adapt an HFC system which sends analog video channels to a conventional analog TV however requires an adapter which can tune the desired digital channel and cull out the MPEG packets in the transport stream having the PID of the desired channel. That is the function of tuner/demodulator 120. This unit 120 functions to detect what channel the tuner 110 is tuned to by detecting the frequency of the radio frequency emissions of the local oscillator 114 and making a deduction as to what channel the user has commanded the tuner 110 to tune in. This channel number is then mapped to a particular digital channel center frequency and a particular subchannel PID within that digital channel. This digital channel is then tuned in by tuner 120 from the signals on HFC coaxial cable 122, and the particular subchannel's MPEG packets are demultiplexed by an MPEG transport stream demultipexer. The resulting MPEG packets of the desired digital channel are then converted to a baseband analog video signal, and that signal is modulated onto an RF carrier having the center frequency of the analog video signal TV channel requested by the user. This conventional analog TV signal at the frequency of the requested analog TV channel is then output on line 124 which is coupled to the RF input of the conventional TV.

FIG. 5 is a more detailed block diagram of the tuner/decoder 120 that does not require its own remote and which provides digital video tuning capability. A radio frequency receiver 126 detects the RF emissions of local oscillator 114 and counts the frequency thereof. The frequency of these emissions is communicated on bus 128 to a microprocessor or inference engine and control logic 130. The function of the microprocessor or inference engine is to deduce the analog TV channel the user has requested from the frequency of the emissions of the local oscillator 114 and generate suitable control signals to control an RF tuner 132, an MPEG transport demultiplexer 134 and a remodulator 136 to do the right thing. Specifically, the microprocessor or inference engine 130 receives data on line 128 that defines the frequency that local oscillator 114 in FIG. 4 is generating. This data is used as a search key to search a look up table that relates frequency of the local oscillator 114 to the requested analog TV channel number and the corresponding digital TV channel number and frequency, the corresponding subchannel PID number and an output frequency. The results of the search are used to generate a control signal on bus 148 which causes RF tuner 132 to tune to the proper center frequency of the digital channel that maps to the requested analog TV channel and tune it in. The results of the search are also used to generate control signals on bus 150 which tell the MPEG transport demultiplexer which MPEG packets (selected by the PID defined on bus 150) to select out of the MPEG transport stream on bus 152. The results of the search cause the microprocessor 130 to also generate the proper control signals on bus 154 which tell the remodulator 136 what frequency of RF carrier to generate for purposes of being modulated with the analog TV signal received on line 158 from MPEG decoder 156.

One embodiment of a lookup table used to do the mapping and which is searched by the microprocessor 130 or inference engine is shown in FIG. 6. The table has one column 138 for the local oscillator frequency, a column 140 for the analog TV channel number that corresponds to that local oscillator frequency, a column 142 for the corresponding digital TV channel number and its center frequency that is mapped to the requested analog TV channel number, a column 144 for the corresponding subchannel PID that is mapped to the requested analog TV channel number, and a column 146 that contains the output frequency of the RF carrier onto which the requested digital data is remodulated as a conventional analog TV signal. This will be the center frequency of the requested analog TV channel listed in column 140, so column 140 and 146 can be combined by using a data structure where a certain number of bits define the analog channel number and the remainder of the bits in the field define the output frequency for that channel.

The lookup table is used by the microprocessor 130 as follows. Suppose a local oscillator frequency of XX is detected by the receiver and frequency counter 138. This data is used by the microprocessor to search the table and an entry in row 160 is found for that frequency. Field 162 tells the CPU 130 that this frequency of local oscillator emissions means the user requested analog TV channel AA which has a center frequency of DD as indicated by the data in field 164. This also tells the CPU 130 that the corresponding digital channel is BB as indicated by the data in field 166 and that the corresponding subchannel PID is CC that maps to analog TV channel XX. BB is then used by the CPU to generate a control signal on bus 148. This causes a local oscillator in RF tuner 132 to generate an appropriate frequency to beat down the center frequency of digital channel BB to an IF frequency at the center frequency of a SAW bandpass filter 170. The SAW filter filters out signals that are not part of the desired digital channel. The filtered signal is output on line 172 to a digital demodulator 174. The digital demodulator is a known circuit, and any digital demodulator in the prior art such as the Hughes DirecTV receivers or the digital demodulator in any set top box with digital video reception capability will suffice for circuit 174. The digital demodulator which typically performs the following functions. It filters the received data in a matched filter, it sometimes filters the received data in an equalization filter, it detects the payload data in the received constellation points and uses Viterbi decoding to use the redundant bits to do error correction if Trellis Coded Modulation was used, it outputs payload data, deinterleaves the bits of payload data to reconstruct Reed Solomon code words, error corrects the code words, deinterleaves the RS codewords to reassemble the original MPEG transport stream which is then output on bus 152. An optional conditional access circuit 176 then descrambles the data if the user is an authorized subscriber.

The microprocessor 130 uses the CC data in field 168 to generate a signal on bus 150 that indicates the PID of the MPEG packets to be culled out of the MPEG transport stream by MPEG transport demultiplexer 134. These MPEG packets are culled out and sent to an MPEG decoder 156. The MPEG decoder 156 converts the MPEG packets to an analog video signal on line 158.

The microprocessor 130 then uses the DD data in field 164 to generate a control signal on bus 154 which tells remodulator 136 the desired output frequency of a radio frequency carrier signal the remodulator generates. The analog video signal on line 158 is then modulated onto this carrier signal, and the modulated RF signal is output on line 124 to the TV RF input. The user can then view the selected digital channel simply by selecting a channel number with the conventional TV remote control which maps to that digital TV channel and subchannel PID encoding the video signal of the desired program.

It is also possible to manage the circuitry in FIG. 5 from the CMTS by in-band management and control information sent to a DOCSIS compatible cable modem (CM) 190 which is included in some alternative embodiments. The CM 190 is coupled to HFC system 192 and structured to locate a valid DOCSIS downstream channel therein and do all the conventional DOCSIS process of training, registering with the CMTS etc. The CMTS can then send management and control information to the CM which is passed to the microprocessor 130 (or inference engine) via bidirectional bus 194. The microprocessor uses this management and control information to manage the spy dongle of FIG. 5. Upstream status information or other requested information is passed back to the CM from the microprocessor on bus 194 (the same is true for the refurbished digital set top box of FIG. 2) and is sent upstream to the CMTS by the CM. Additionally, the CM can have an optional LAN, USB, SCSI or other output 196 suitable for coupling to other customer premises equipment such as personal computers, IP telephony equipment including phones, FAXes, video conferencing apparatus, security cameras, digital video recorders with LAN inputs or anything else which can use DOCSIS digital broadband data.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. For example, any other method other than using a look up table may also be used to do the mapping function. All such alternative embodiments and other modifications are intended to be included within the scope of the claims appended hereto.

What is claimed is:

1. A process comprising the steps of:
1) determining the frequency generated by a local oscillator in an analog TV tuned to a particular requested analog TV channel;
2) mapping said frequency to a corresponding digital video TV channel frequency and subchannel PID number;
3) using the information determined in step 2 to tune to the corresponding digital video TV channel recover an MPEG transport stream from the signal on said digital video TV channel and extract MPEG packets having the PID recovered in step 2;
4) converting the MPEG packets recovered in step 3 to an analog video signal and modulating said analog video signal onto an RF carrier having the frequency of said requested analog TV channel.

2. A process for using the frequency generated by a local oscillator in an analog TV tuned to a specific analog TV channel number to retrieve the digital video data in a digital video channel and subchannel mapped to said analog TV channel number, comprising:
1) detecting the frequency of a local oscillator signal of a conventional TV that has been tuned using the TV remote control or front panel switches on a conventional analog TV to a specific analog TV channel number which maps to the desired digital channel number;
2) mapping the frequency of the local oscillator signal so detected to a corresponding digital channel defined by a digital channel number and/or frequency, and mapping the frequency of the local oscillator signal so detected to a corresponding PID which identifies the particular corresponding subchannel carried by said corresponding digital channel which carries the desired digital video program and mapping the frequency of said local oscillator to the center frequency of the analog TV channel number which a user of said TV requested;
3) generating control signals that cause a tuner to tune to said corresponding digital channel frequency and filtering out signals outside said corresponding digital channel;
4) demodulating the signal of said corresponding digital channel to re-create an MPEG transport stream carrying said desired corresponding subchannel;
5) using said PID located in step 2 to generate control signals which cause an MPEG transport demultiplexer to cull out MPEG packets from said MPEG transport stream recovered in step 4 which carry the data of said desired corresponding subchannel;
6) converting said MPEG packets recovered in step 5 to an analog video signal; and
7) using the information found in step 2 regarding the center frequency of the analog TV channel number which a user of said TV requested (hereafter the requested analog frequency) to generate control signals which cause a remodulator circuit to generate an output radio frequency carrier having said requested analog frequency; and
8) modulating said analog video signal generated in step 6 onto said RF carrier signal generated in step 7.

3. An apparatus comprising:
a radio frequency receiver and frequency counter to receive and determine the frequency of radio frequency emissions of a local oscillator of a tuner of an analog TV which has been tuned to a requested analog TV channel;
a computer or inference engine coupled to receive the frequency detected by the frequency counter and programmed to use said frequency to look up a corresponding digital video channel frequency and the PID of a corresponding subchannel in an MPEG transport stream carried on said digital video channel;
means coupled to said computer for receiving control signals generated by said computer using said digital video channel frequency and said PID and tuning said corresponding digital video channel in and recovering an MPEG transport stream and recovering MPEG packets having said PID from said MPEG transport stream and converting said MPEG packets to an analog video signal and modulating said analog video signal onto an RF carrier having the frequency of said requested analog TV channel.

4. The apparatus of claim 3 further comprising a DOCSIS compatible cable modem coupled bidirectionally to said computer and inference engine.

5. The apparatus of claim 4 wherein said DOCSIS compatible cable modem includes a local area network output or any other output capable of being coupled to digital computing equipment in the customer premises.

6. A process for managing a digital tuner/decoder located in a customer premises on a CATV system, said digital tuner/decoder having a DOCSIS compatible cable modem which is coupled to a cable modem termination system (CMTS) by a cable TV signal distribution system, said digital tuner/decoder functioning to tune to digital TV channels, recovers MPEG packets having a PID that corresponds to a video program a user wishes to watch on a TV and converts the MPEG packets to a signal the user can watch on said TV, said process comprising:
sending managment and control information needed to manage said digital tuner/decoder to said DOCSIS compatible cable modem from said CMTS via a DOCSIS data channel; and
using said management and control information received from said CMTS via said cable modem to manage said digital tuner decoder.

7. A digital set top tuner/decoder made from an analog set top tuner/decoder, comprising:
a printed circuit board of said analog set top tuner/decoder (hereafter referred to as the motherboard), said printed circuit board including circuits to be re-used including an infrared receiver, a voltage regulator, a tuner, an analog SAW filter, and a remodulation circuit as well as various discrete components such as resistors, capacitors and possibly inductors, and including circuitry that is not to be re-used;
an enclosure having LEDs, possibly front panel switches, a window for receiving infrared commands, an RF input connector and an RF output connector, and a DC input connector to receive DC power to power circuitry on said motherboard all of which were present in said analog set top tuner/decoder and which are to be re-used;
a power supply and cables to connect said power supply to a wall power outlet and to said DC power input connector on said enclosure, all of which were present in said analog set top tuner/decoder and which are to be re-used
conductors to connect circuitry on said motherboard to said LEDs, said front panel switches if any, and said RF input connector and said RF output connector and said DC power input; and
a replacement circuit board having circuitry formed thereon which performs functions which, when suitably connected to said circuitry and components on said motherboard and said enclosure to be re-used will convert said analog set top tuner/decoder into a digital set top tuner/decoder, said replacement circuit board physically mounted to said motherboard and electrically connected to predetermined points of circuitry on said motherboard so as to create a digital set top tuner/decoder which re-uses circuitry and apparatus from said analog set top decoder thereby greatly saving on the expense of building a digital set top tuner/decoder;
and wherein said replacement circuit board includes a chip set or integrated circuit implementing a DOCSIS cable modem.
